(19) United States
(12) Patent Application Publication
(10) Pub. No.: US 2012/0317914 A1
(43) Pub. Date: Dec. 20, 2012

(54) Continuous thermal insulation and fire protective composite placed on thermo-grid designed for wind load transfer

(76) Inventors: Mark Bomberg, Ottawa (CA); Nicole Bomberg, Ottawa (CA)

(21) Appl. No.: 13/385,481

(22) Filed: Feb. 22, 2012

Related U.S. Application Data
(60) Provisional application No. 61/520,871, filed on Jun. 20, 2011.

(51) Int. Cl. E04B 1/94; B32B 38/16; B32B 37/14

(52) U.S. Cl. 52/443; 156/281

(57) ABSTRACT

The present invention relates to construction materials and more specifically, to a continuous composite exterior insulation system and cladding used in the construction of building walls and structure, to control heat transfer, rain-water penetration, air and water vapor transmission while providing fire protection to a building enclosure. This invention relates to a thermal upgrade of existing and new buildings. The wall substrate is arranged for receipt of subsequent layers of cladding materials. Thermo-grid of insulated composite strapping is mounted on the surface of the said wall and a layer of continuous insulation e.g. polyurethane foam is applied between the thermo-grid strapping leaving a thin air gap between it and the next layer of the fire protective composite.

### BACKGROUND OF THE INVENTION

1. Field of the Invention

The present invention relates to construction materials and more specifically, to a continuous composite exterior insulation system and cladding used in the construction of building walls and structure, to control heat transfer, rain-water penetration, air and water vapor transmission while providing fire protection to a building enclosure. This invention relates to a thermal upgrade of existing and new buildings and extends the utility patent (exterior building wall Insulation System with Hygrothermal Wrap application Ser. No. 12/807,730 by Bomberg that was based upon Provisional Patent Application Ser. Nos. 61/342,513 filed 15 Apr. 2010, 61/399,497 filed 13 Jul. 2010, and 61/520,871 filed 20 Jun. 2011, each being incorporated herein by reference in their entirety. The wall substrate is arranged for receipt of subsequent layers of cladding materials. Thermo-grid of insulated composite strapping is mounted on the surface of the said wall and a layer of continuous insulation e.g. polyurethane foam is applied between the thermo-grid strapping leaving a thin air gap between it and the next layer of the fire protective composite.

Fire protective composite uses either traditional wood fiberboard, mineral (glass or basalt fiber) fiberboard or newly invented eco-board insulation that is mounted on the thermo-grid and base coat of polymer modified climatic stucco or eco-wrap defined in a non-provisional patent listed above that is applied on the surface of the said insulating fiberboard to provide adhesion of a subsequent layer of climatic stucco or lamina of the exterior insulation and finish system (EIFS). A next layer of the EIFS or climatic stucco is applied over the surface of the composite and final coat with the required color and texture is applied thereon.

2. Description of Prior Art

A modern building wall includes a layer of exterior thermal insulation covered by a rain intrusion protection such as siding or plaster (stucco) or thin lamina of EIFS. Thermal insulation material can be impermeable or permeable to water vapor. Stucco can be a “three-coat stucco” (for example, a 3-coat, traditional, metal-lath-reinforced, cladding system) or one-coat stucco (for example, a reinforced stucco applied in two layers) or a “synthetic stucco” (for example, a thin lamina reinforced with fiberglass or polymeric mesh) used in Exterior Insulation and Finish Systems (EIFS). In this prior art practice, once polystyrene foam insulation sheets are attached to the wall, they are roughened by a rasp to permit a base coat of polymer paste reinforced with a fiberglass fabric mesh, to help bind subsequent material to that foam, and to unify those blocks together. That mesh in the prior art method, would be placed over the roughened outer surfaces of those blocks of foam on a base coat while still wet, to embed that mesh in the base coat. The base coat of are trowelled before the finish coat of synthetic stucco is applied. Typical problem with a prior art is that joints between the adjacent boards may induce cracking in the outer surface layers of material if those boards are not installed tightly against one another and the wall. Furthermore the degree of fire protection is limited and in many countries those systems are not allowed on high-rise-buildings.

In the previous art plasters (or stuccos) provide a barrier to rain entry. While the old masonry buildings used renderings with slack lime as the binder and provided substantial capillary action, the newer renderings based on cement generally use polymeric admixtures to reduce the capillarity of the material. In effect, the conventional rain controlling elements in building enclosures are focused on the reduction or elimination of moisture entry into buildings. For example, hydrophobic coatings or other film forming compositions may be applied on the exterior surface of Portland Cement Plaster to provide low water transmission, while retaining good flame retarding property and low smoke generation of the plaster. Similarly, a coating of polypropylene resin can be applied to the surface of a fibrous sheet to make the sheet impermeable to water and vapor. Subsequent treatment provides vapor permeability to the sheet while maintaining liquid water impermeability. The resultant product is particularly suited for use as a roofing-tile underlayment or as an air-infiltration barrier. Alternatively, water barriers may be coated with other elastomers including dispersed layer fillers in liquid carriers, or may include a sheet of paper impregnated with asphalt or urethane compounds. Yet the 3-coat Portland Cement Plaster is prone to cracking and subsequent moisture penetration.

On the other hand, “synthetic stucco” (a thin lamina reinforced with fiberglass mesh) is elastic and less prone to cracking but it does not provide sufficient fire protection and drying ability to the wall as well. It also lacks the “moisture storage capacity” of the traditional 3-coat lime-cement stucco.

While all those considerations were addressed in previous patent application Ser. No. 12/807,730 by Bornberg “Exterior Building Wall Insulation Systems with a Hygro Thermal Wrap”, this invention covers a new class of composite systems and expands our capability to use the traditional 2×4 wood frame walls, masonry or concrete blocks and achieve very high thermal resistance needed for low energy buildings. Furthermore, by joining with another stream of development of thermal insulation technology we have incorporated many performance aspects under one novel system.

It is an object of the present invention, to provide a novel climatic stucco on continuous fire protective composite insulation that may be separated by an air gap from another continuous layer of thermal insulation to create a wall arrangement that will overcome typical problems of the prior art. It is a further object and advantage of the present invention to provide an insulated cladding system for new buildings, or retrofit to existing buildings that provides adequate rain water absorption, storage and accelerated water removal capability. While the previous invention dealt with the layered system in which each layer was different but homogenous in direction parallel to wall surface, this invention introduces structural members positioned in the direction perpendicular to the layers called here thermo-grid that carry the mechanical loads while allowing continuity of thermal insulation.

It is a further object of the present invention, to provide a climatic stucco wall construction which will prevents the entry of water into the existing wall surface and allow drying of water that accidentally entered into the wall structure say at wall-window interface.

It is still yet a further object of the present invention, to provide a climatic stucco construction arrangement which is easily applied, readily modified to accommodate variations in the existing wall's characteristics, and permit an even exterior surface for subsequent coat applications.

It is yet still a further object of the present invention to provide a climatic stucco construction arrangement that is fast, easily applied, energy efficient, strong and which is designed with consideration of the climatic conditions of the region and one that will outlast the prior art stucco construction by many years.

This invention is applicable to thermal upgrade of any existing wall or new construction by providing two layers of continuous exterior insulation and addressing heat, air and moisture control of the upgraded wall as well as increased fire protection for wood frame walls. Other objects and advantages of the present invention will in part be apparent, and in part appear hereinafter.

### OBJECTS AND ADVANTAGES OF THE PRESENT INVENTION

It is a principal object and advantage of the present invention to provide an external insulating cladding system and a process of construction of that insulating system onto a wall, leading to an assembly for that accelerates drainage and drying of moisture encapsulated during construction of the building or the building enclosure.

It is an additional object and advantage of the present invention to provide a system and method for dealing with the moisture that comes from incidental rain leaks at windows or other penetrations or failures of the vapor barrier of a building or its enclosure.

It is a further object and advantage of the present invention to provide an insulated cladding system for new buildings, or retrofit to existing buildings that provides adequate rain water absorption, storage and accelerated water removal capability and increased fire protection. While the previous invention dealt with the layered system in which each layer was designed with a view to control moisture balance, this invention introduces structural members positioned in the direction perpendicular to the layers called here thermo-grid that carry the mechanical loads while maintaining the continuity of thermal insulation and reinforce the moisture control aspect by creating unvented, vented or ventilated air cavity.

It is another object and advantage of the present invention to provide a system and method for constructing an improved fire protection for thermal upgrade system applied to the existing buildings. Other objects and advantages of the present invention will in part be apparent, and in part appear hereinafter.

### BRIEF SUMMARY OF THE INVENTION

The current invention proposes a cladding system that improves the prior art of building the highly insulated walls on the basis of building physics and one, previously patented material solution. Thus, some traditional insulation materials such as wood fiberboards and mineral fiber boards can be used in parallel to the newly invented materials such as eco-wrap and eco-board. This invention uses two parallel, continuous layers of thermal insulations (1) close cell polyurethane foam (ccPF) or any other type of thermal insulation e.g. vacuum insulated panels or foams if so is desired and (2) fire-protective insulating composite divided by a thin air gap. The fire-protective insulating composite is mounted to thermo-grid manufactured from ccPF and wood (plywood) or a plastic profile.

The process of construction includes the following stages: (1) Preparation of surface of the existing building, (2) Mounting the thermo-grid, (3) Installation of continuous thermal insulation layer e.g., polyurethane layer between the thermo-grid,

(4) Mounting of the fire-protective insulating composite, (5) application of the required finish such as EIFS lamina or climatic stucco providing that its water vapor permeability is designed with a view to a balance between wetting and drying in the given climatic conditions.

Thermo-straps must fulfill the requirements of load transfer and continuity of thermal insulation. Effectively the material of the thermo-straps must be water resistive and have similar thermal efficiency as the cavity insulation. As the outer layers of the cladding system are now mechanically attached, one can place the air space on the either side of the thermal insulation. For enhanced drying of the OSB sheathing the air gap could be on the inner side, for removal of moisture coming from hot and humid outdoors, the air gap could be on the outer side of the cavity. Furthermore, the presence of an air gap between moisture resisting material of polyurethane foam and drainable material of mineral fiber permits use of evaporative drying in the ventilated wall systems in hot and humid climates. Alternatively the air gap can be replaced by a drainage mat.

Where the wind loads are limited, the thermo-grid can be made from thermal insulating composite. Where wind loads are significant, e.g. for high rise buildings the thermo-grids could be made from durable plastic profiles. The objective of this invention is to maintain continuity of the thermal insulation layer that is controlling heat, air and moisture flows and the second layer that provides fire protection and some thermal resistance as well as the structural rigidity and wind load transfer in addition to increasing the capability for moisture removal. Furthermore, this cladding system recovers quickly from flood as it accelerates rate of moisture removal from the building enclosure. The air gap allows diffusion of water vapor in such a way that no air movements are created either by convention or by air pressure differences. The air gap uses buoyancy forces for water removal. When drainage is not necessary the air gap can be eliminated and use of the eco-wrap (a type of climatic stucco described in the previous patent) that also permits on accelerated drying of the wall) is recommended.

The present invention relates to a method for the application of multiple layers of materials to an existing wall, so as to produce a water impenetrable and easy drying exterior insulation cladding system.

In the application of the present method of constructing such a structure, the existing wall may be pressure washed if dirty, cleaned, rinsed and air dried. The existing wall may be any type of structure such as wood frame, metal frame, and metal cladding or clay-brick, stone or cement blocks. After the wall has been cleaned, an arrangement of orientation of thermo-grid screeds is applied to the wall, as well as to the periphery of any windows or doors.

A thermo-grid may have a rectangular cross-section or “C” shape or double “T” shape having a shoulder on which the foam is sprayed. The thermo-grid is attached to the wall by an adhesive and/or rust protected mechanical fasteners. Different fasters are used for wood frame than for masonry wall. Thermo grid can also be made of plastic with thermal breaks forming compartments, typically filled with foam insulation or plastics extruded in “J”-shaped channel arrangement having one side edge which is attached by adhesives and or mechanical fasteners, to the margins of the wall and to the periphery of any door or window openings thereon. The urethane plywood composite used for limited wind-loads e.g. small houses also provides a method of determining the thickness of subsequent application of foam urethane.

The next step in the construction of a continuous thermal insulation and stucco-fiberboard fire protective composite with thermo-grid for load transfer is to cover any openings (doors, windows) with plastic, prior to the application of the foam spray so as to prevent any inadvertent overspray into undesired areas.

One may use one of two fundamentally different construction systems; (a, b) spray foam and (c) poured foam.

Spray foam is applied with a pass not thicker than 1.5 inch to the desired foam thickness. Thermo-grid should be ¾ inch thicker and the last ¾ inch should be marked so that spray foam is not thicker than ¼″ above the thickness mark. If poured foam is used, there may or may not be air cavity.

With presence of air cavity the forces of wind uplift must be carried from the thermo-grid to the exterior thermal insulation board. If wood or basalt fiberboard is used for the fire protective composite the minimum density is 110 k/m3 or 7 lb/ft³, for glass fiber 140 k/m3 or 8.5 lb/ft³.

The requirements for either EIFS lamina or eco-wrap that are used as exterior finish of the wall are independent of the insulation type but designed differently for warm, mixed and cold climates. As discussed elsewhere, an eco-fiber board consists of fiber mix that may include organic and inorganic fibers mixed with small particles and bonded with one or two types of adhesive or melting fibers. The eco-wrap is comprised of three types of substances (1) a “binder” that include S-type hydrated lime mixed with natural cement and Portland cement, (2) a “natural fibrous aggregate” such as coming from recycled wood, newsprint or other biological fibers that may be mixed with and post industrial recycled and fiberized materials or post consumer ground glass and (3) a selected “mix of biological and industrial polymers” utilized to provide required dispersion of the recycled materials and bonding to the substrate. The polymer mix determines the moisture retention and the curing rate of the eco-wrap, for the process of construction of the eco-wrap see the previous invention. The traditional textured and pigmented coating or appropriate paint (mineral oil) can be applied on the top of the eco-wrap or a traditional finishing layer placed on the eco-wrap.

### BRIEF DESCRIPTION OF THE DRAWINGS

The present invention will be better understood when reading the following detailed description in conjunction with the accompanying drawings, in which:

FIG. 1 is a cross-sectional schematic of the composite of the protective thermal insulation 12 with an “eco-wrap” bonding layer 13, and other layers constructed according to the principles of the previous invention;

FIG. 2 is a cross-sectional schematic of insulating cladding with an “eco-wrap”, “eco-board” and “thermo-grid” layers constructed according to the principles of the present invention and represents system c) with drainage by means of air gap;

### DETAILED DESCRIPTION OF THE PREFERRED EMBODIMENTS

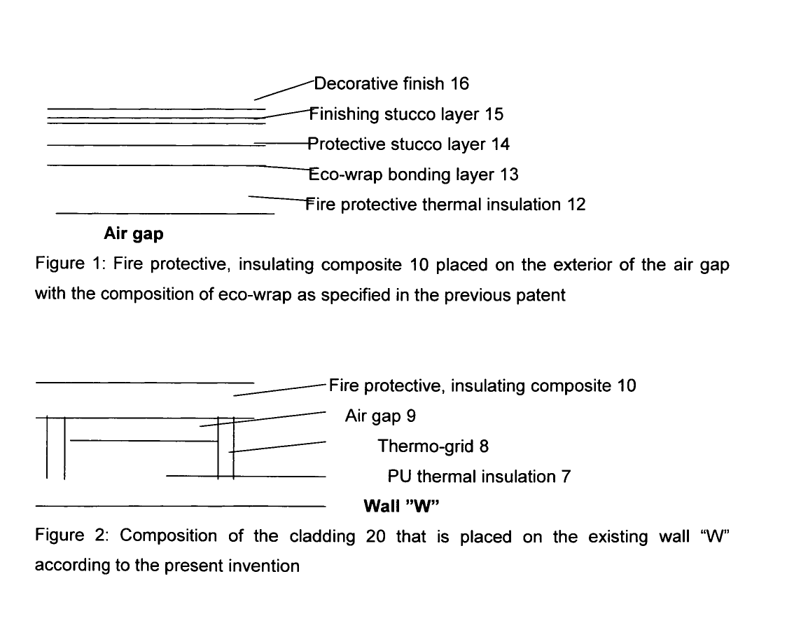

Referring now to the drawings herein, the numerals refer to parts throughout, for controlling the rate of air, vapor, and liquid water flow across the wall “W” of a building enclosure, as may be seen herein below, in FIG. 1, representing a part of fire protective, insulating composite 10. This system as shown in FIG. 1 restricts the passage of air and liquid water while permitting the transfer of water vapor to a degree required by the particular climatic conditions. The rate of water vapor transmission across the system is also controlled by the components of the wall assembly and may also be affected by the moisture content of layers 13 and 14 shown in FIG. 1.

The fire protective, insulating composite 10 applied to a wall “W”, comprises an eco-wrap bonding layer 13, a protective stucco layer 14 and a finishing stucco layer 15. The eco-wrap bonding layer 13 and the protective stucco layer 14 are preferably identical or nearly identical in composition and thickness and have a thickness of about 1/16 to ¼ in (1.5 to 6 mm) each and constructed so as to ensure that the reinforcing mesh is placed in the middle of the protective stucco layer 14. The layers 13 and 14 contain inorganic binders and fillers, for example: lime, cement and fly ash mixed with organic, recycled materials, for example: wood and cellulose fibers fiberized and ground to the particle size as for example: recycled glass mesh 80, but generally as needed to accomplish several elements of their performance such as (1) provide the required characteristic length allowing for expansion of the freezing water and thereby providing high degree of freeze-thaw durability, (2) provide the interruption in the crack propagation through the brittle inorganic matrix of the stucco and thereby reduce shrinkage and cracking ability (3) provide a degree of elasticity to accommodate movements caused by the structure or gas-filled thermal insulating materials of the HT wrap substrate.

The fire protective, insulating composite 10 provides required protection under conditions involving prolonged presence of water and thermal gradients with water storage related to physical properties of the composite and considered climate. In cold and mixed climates, the layers 13 and 14 are enclosed by a thermal insulation on one side and permeable for water vapor finishing layer 15 on the other side. In climates with a frequent interim wetting and drying, the layers 13 and 14 are designed with lower water vapor permeance. Different aggregate compounds may be used to modify moisture characteristics of the layers 13 and 14. An inorganic layered silicate, such as bentonite, vermiculite, or montmorillonite, or selected particulate such as silica, diatomous earth or fly ash can be used for these layers made as a dry premix of binder, recycled aggregate and polymers. The outer layers 15 and/or 16 may also be pre-treated with ingredients which act as biocides e.g., bark of pine tree and enhance protection from microbial deterioration in the form of mold. Other polymeric compounds can also be incorporated into layer 16 to expand the range of control over water, and vapor transport.

Generally, the control of the resistance to liquid water flow and ability to transfer water vapor are achieved by the pore structure of each layer of the composite 10, as well as by the interface between layers 14 and 15. The composite laminate and micro-porous structure of the eco-wrap layer 13 is also less susceptible to shrinkage during drying (typically less than 0.3% after de-molding of the test specimen). Increased water retention of the eco-wrap to extend its pot life and to eliminate need to additional wetting during the curing time makes it resistant to cracking during the shrinkage periods. Effectively, the composite 10 has improved resistance to cracking in comparison to conventional stuccos currently used in the exterior insulation systems.

The present invention includes the design of two classes of the eco-wrap that are designated for use in various climates, according to standard building specifications with different water vapor transmission.

The first class of the fire protective composite 10 is semi-impermeable for water vapor (WV) and has WV permeability coefficient measured by ASTM E96 dry cup method of

With the rate of air transmission of the protective composite 10 tested at 50 Pa that is lower than 0.02 l/m²sPa, this material is also suitable for air control in hot and humid environments. The second class of the fire protective composite 10 is semi-permeable, and has a water vapor permeability coefficient measured by ASTM E96 dry cup method between 4 perm and 8 perm (230 to 460 ng/(m²sPa) and is suitable for mixed and cold climate applications.

The fire protective composite 10 also provides additional protection measures from moisture that is enclosed during the construction process, or that infiltrates from incidental water leakage. For enhanced dissipation of incidental water leakage, the finishing stucco layer (15) or the decorative coating (16) may include a granular finish. The eco-wrap may thus be used in many applications where enhanced moisture removal is required, such as walls prone to heavy rain loads, on concrete block walls in basements, or other applications where enhanced drying capability is needed.

FIG. 2 expands the previous invention to the universal cladding system that can also provide ventilation and/or drainage independently of the materials used. The Drawings shows a Schematic drawing of the exterior cladding system 20 (FIG. 2) that includes all layers comprised in the protective composite 10, as well the thermal insulation 7 separated from the surface of fire protective composite by air gap 9. While the name “drainage layer” is customary in the building codes for the air gap the actual physical mechanism of moisture removal relies more on the diffusion of water vapor though the air and specially designed micro-drains than actual liquid water flow. Finally, the thermo-grid 8 is attached to the wall “W”. In many actual designs of this system the bottom layer of the fire protective composite (eco-wrap bonding layer) is also mechanically fastened to the structure of the thermo-grid network.

### Example 1

### An External Insulation System for Cold Climate

Since 1994 flexible and rigid wood-fiber insulation boards have been produced in Germany in accordance with a standard WF-EN 13171-T3-CS (10/Y) 20-TR7, 5-WS2, 0-MU5-AF100. When a multi-fiber system is used as an additive to the wood fibers to modify its physical properties this product is known as “Eco-fiber board”. The material came from Homatherm GmbH in Berga, Germany. It has density about 140 kg/m³, a thermal conductivity measured at 10° C. equal to 0.037 W/mK or thermal resistivity of 3.75 (of hr ft²)/BTU in, specific heat 2100 J/(kgK) and thickness 40 mm (1⅝ inch). It was mechanically fastened to thermo-grid using epoxy covered screws and plastic washers The HT wrap (the layers 13 and 14) was from a pilot production of Sto Corp with the mix was designed in accordance with this invention. Glass fiber mesh (5 oz) was placed between the layers 13 and 14. The layer 15 was a StoSilco®Lastic—a ready-mixed, silicone-enhanced, smooth elastomeric exterior wall coating that is weather and mildew-resistant. Total thickness of the HT wrap was 12 mm. No special treatment (16) was used.

### Example 2

### External Insulation System for Warm Climate

There was no air gap in is example but a poured close cell polyurethane foam was applied with 2 ft increments between thermo-grid placed on each stud and serving as locations of the mechanical fasteners for the protective composite. In the actual example foams from two different manufacturers were used. One of the foams had CCMC 12840-Report that describes the technical features as follows: The final cured product has a nominal density of 30.4 kg/m³ and an assigned design thermal resistance of 1.05 m2·° C./W per 25 mm (R6 per inch). Compressive strength is 222 kPa and tensile strength 337 kPa that is sufficient to ensure adhesion to the substrate and cohesion of the foam.

In this example, the HT wrap had additional admixture of layered silica to reduce its WVT and the finishing layer applied on an HT-wrap was acrylic coating with permeance below 1 perm.

Notes on the Examples of this Invention

This system has several options that depend on the climatic and service conditions. For 1½ inch thick foam the water vapor permeance of this foam is about 1.5 perm i.e. is semi-permeable. For exposed conditions with coastal climate and high winds it is preferable to use a drainable system with the drainage layer as discussed above. This layer is connected to venting and flashing on the level of floor that leads water outwards. For less exposed locations in Central or Western US, an eco-board of the required thickness may be used with poured foam behind it. Use of horizontally placed eco-fiber boards changes the pattern of work and leads to filling the whole perimeter of the house in horizontal increments of height.

### Overview of the Invention

This invention covers a process of construction leading to an external insulating cladding system that accelerates moisture removal by drainage and drying of moisture encapsulated during construction, or moisture that comes from condensation or incidental rain leaks at windows or other penetrations. This invention also covers an insulated cladding system for new building construction or an insulation system which is to retrofit to walls or roofs of existing buildings to provide adequate rain water absorption, storage and removal capability. To accelerate the process of moisture removal, the following measures may be utilized: (1) drainage capability; (2) temporary moisture storage capability, (3) negative wetting angle preventing water flow combine with high water vapor permeance of eco-fiber, (4) sequence of material with a higher activity index or higher storage capability. This invention introduces structural members positioned in the direction perpendicular to the insulation layers called here thermo-grid that carry the mechanical loads but maintain the continuity of thermal insulation while allowing space for so-called drainage layers.

The present invention recognizes that building enclosures must be designed differently for various climates and therefore the principles defined in this invention description may have different representation in warm, mixed or cold climates. The process of construction covered by this invention comprises two continuous thermal insulating layers: (1) polyurethane foam or other insulation (2) fire protective, insulating composite. Both thermal insulating layers are continuous and permeable for water vapor. To allow drainage and diffusion-based drying the current invention includes provides mechanically fastened systems with highly effective thermo-grids. In this manner the continuity of high performance insulation is ensured.

Eco-wrap system comprises of: an eco-wrap bonding layer (13) and a stucco protective layer (14), those layers being identical in the capillary active and hygroscopic behavior, the latter layer incorporating the reinforcing mesh in the middle and a finishing (15) layer adhered to the stucco protective layer (14) that may or may not be covered with an exterior paint layer (16), wherein the water vapor permeability of this system is directionally sensitive. If water falls on the layer 16 or layer 15, the moisture transmission coefficient is lower than when tested from the inner layer 13 to the exterior layer 16. Furthermore, the intermediate layers 13 and 14 may change water vapor transmission coefficient with a change in moisture content of the material.

The binder in layers 13 and 14 include hydraulic lime modified with natural and Portland cements. The layers 13 and 14 may include at least one compound selected from the group of inorganic layered silicates. The inorganic layered silicate may comprise at least one compound selected from the group consisting of bentonite, vermiculite, montmorillonite and colloidal clay. The inorganic layered silicate may comprise an alkali metal polysilicate solution. The layers 13 and 14 may include at least one compound selected from the group of natural cements. The natural cement may comprise at least one compound selected from the group consisting of fly ashes or pozzolanic materials (metakaolin, ground brick, and enamel glass). The layers 13 and 14 may include at least one compound selected from the group of bio-fibers. The bio-fibers may comprise one fiber type from the group consisting of wood, cellulose, hemp, flax, jute or bamboo. The layers 13 and 14 may include at least one compound selected from the group of regrind/recycled material such as expanded polystyrene coming from molded products such as boards, cups or packaging materials or glass.

This recycled material may be ground to the fiber or particle size as needed, for example, about 60 to about 240 microns to provide the required characteristic length for a number of performance aspects:

1) To allow for expansion of the freezing water and thereby providing high degree of freeze-thaw durability;

2) To provide the interruption in the crack propagation through the brittle inorganic matrix of the stucco;

3) To provide a degree of elasticity to accommodate movements caused by the structure and gas-filled thermal polyurethane foam

The layers 13 and 14 may include at least one compound selected from the group of bio-chemical and industrial surfactants, dispersive and bonding polymers. These polymers may provide multiple functions e.g. hydroxypropyl methyl cellulose not only increases bonding and allows usage of a non-wetting aggregate taken from the recycling but also reduces the volumetric fraction of water added to the dry stucco. The reinforcing mesh, placed in the middle of layer 14 (see FIG. 1) is made either of metal or polymers (fiberglass, polypropylene etc). Any of the layers 13, 14, 15 or 16 may includes a biocide.

The layer 16 is optional. It may include an additional granular admixture or micro-pores to enhance the transport of moisture. The layer 16 may further comprise fillers for improving the radiant barrier properties. The surface finish on the layer 15 may include at least one hygroscopic compound selected from the group consisting of diatomous earth, fly ash, silica powder or ground bark. The layer 15 may be covered with surface finish (16). The surface finish (16) may be comprised of latex acrylic. The surface finish (16) may be comprised of latex rubber. The surface finish (16) may be comprised of mineral oil. The surface finish (16) may be comprising pigments. The eco-wrap may have an air permeability rate at 50 Pa lower than 0.02 l/m²sPa. When measured with the ASTM E96 standard test method—dry cup, the HT wrap may have water vapor permeability of between 0.1 to 0.5 perms (6 to 28 ng/m²sPa) for use in warm climates or up to 10 perms (570 ng/m²sPa) for use in cold climates.

The primary functions of eco-fiber board are heat and moisture control. It offers significant moisture storage and permits to change the paradigm of design of moisture control. While in wood frame construction traditional EIFS prevent wetting from rain, this invention permit the eco-wrap and eco-board combination to act similar to brick veneer allowing wetting, moisture storage and subsequent drying of the rain water.

Finally, thermo-grid is critical in expanding the hygric and thermal control by providing the air gap. By providing means of flooding protection and diffusion drying not only can one use different moisture sensitive thermal insulating materials but also dry OSB from excess of moisture.

In conclusion, any permeable or semi-permeable external thermal insulating material such as Eco-fiber board, spray polyurethane foam or even expanded polystyrene, when covered with eco-wrap to achieve good drying capability, is the subject of this invention. The method of manufacturing an eco-wrap comprises the one or more of the steps of:

1. Selecting a mix that is comprised of one or two components from each of the three following groups: (1) a binder that include S-type hydrated lime mixed with natural cements and Portland cement filled, (2) a natural fibrous aggregate such as coming from recycled wood, newsprint or other biological fibers mixed with and post industrial or post consumer ground glass etc, and (3) a selected bio-chemical or/and industrial polymeric admixture to provide required dispersion of the recycled thermal insulation materials and the bonding to the substrate. The mix may or may not include at least one additional compound selected from the group consisting of diatomous earth, silica powder or ground bark. The recycled materials may be fiberized or ground to the size as needed to provide improvement of selected performance aspects.

2. The mix preferably includes at least one compound selected from the group of bio-chemical and industrial surfactants, dispersive and bonding polymers. The polymers may provide a multiple function e.g. hydroxypropyl methyl cellulose not only increases bonding and allows usage of a non-wetting aggregate taken from the recycling and reduces the volumetric fraction of water added to the dry stucco mixture.

3. Applying the mix in two layers, where the second layer may have identical composition but a reinforcing mesh is placed in between them. After adequate drying time the finishing layer is applied.

4. Use of thermo-grid for providing continuity of both structural and thermal insulation functions.

The invention thus comprises an external insulation appliqué system for stepped application to a building wall construction, the system comprising: a layer of permeable or semi-permeable thermal insulation arranged onto the wall of the building, covered with eco-wrap consisting initially of three individually applied, climate-dependent layers of:an inner bonding layer arranged onto the layer of thermal insulation; a layer of reinforcing mesh arranged on the inner bonding layer, and a protective layer arranged on the layer of reinforcing mesh, and wherein the inner bonding layer and the protective layer both comprise capillary active and hygroscopic components, wherein the inner bonding layer and the protective layer both comprise capillary active and hygroscopic components, to achieve water resistivity and permit accelerated drying of the exterior insulation system. The layer of thermal insulation is preferably selected from the group comprising: fiber board, open cell polyurethane foam, closed cell polyurethane foam, and expanded polystyrene.

The inner bonding layer and the protective layer both preferably include a compound of inorganic, layered silicate selected from the group consisting of: bentonite, vermiculite, montmorillonite and colloidal clay. The inorganic layered silicate is preferably comprised of an alkali metal polysilicate solution. The bonding layer and the protective layer preferably include at least one compound selected from the group consisting of: fly ashes and pozzolanic materials consisting of metakaolin, ground brick and glass. The bonding layer and the protective layer include at least one compound preferably selected from a bio-fiber group consisting of: wood, cellulose, hemp, flax, jute and bamboo. The bonding layer and the protective layer may include at least one compound selected from a recycled material consisting of: expanded polystyrene and glass.

The bonding layer and the protective layer may include at least one compound selected from a group of consisting of: bio-chemical polymers (extracts from corn, guar gum and sugar cane) from and the industrial polymers such as hydroxypropyl methyl cellulose. The reinforcing mesh layer preferably consists of at least one compound selected from metal and polymers selected from the group consisting of: fiberglass and polypropylene. At least one layer of the hygro-thermal wrap preferably includes a water-retention modifying compound selected from the group consisting of: diatomous earth, fly ash, silica powder and ground bark. The layer of thermal insulation under the hygro wrap consists of a semi permeable film to permit effective drying capability of the building wall under the layer of thermal insulation. At least one of the layers of the hygro thermal wrap may include a biocide compound. The protective layer is preferably covered by a further finish layer selected from the group consisting of: paint pigments, biocides and fillers, comprising the balance of the HT wrap.

The invention further comprising a cladding system comprised of a method of applying a first and a second continuous insulation layer, wherein the second layer is incorporated in a fire protective, insulating composite for insulating and finishing a vertical wall structure which is impervious to water but permeable to water vapor, the method comprising the steps of: cleaning a surface of said wall structure to be treated; mounting a thermo-grid to the surface of the wall; applying the primary insulation layer comprising spraying a layer of polyurethane foam between the thermo-grid, mounting the fire protective composite to the thermo-grid; and applying the finishing layer, comprising a climatic stucco or eco-wrap in two stages, wherein a layer of polymer modified climatic stucco and a reinforcing mesh is applied followed by an outer color and texture treatment. The primary thermal insulation is selected from the group comprising: wood, mineral fiber or insulation using a combination of fiber types (called here eco fiberboard), open or closed cell polyurethane foam, modified expanded polystyrene or vacuum insulated panels. The fire protective, insulating composite includes wood, mineral fiber or insulation using a combination of fiber types (called here eco fiberboard) and the stucco (polymer modified climatic stucco) consists of three individually applied, climate-dependent layers: (1) eco-wrap bonding layer arranged onto the layer of thermal insulation; (2) a protective stucco layer arranged with reinforcing mesh in the middle, and wherein both the bonding layer and the protective layer are comprised of capillary active or/and hygroscopic components, to achieve water resistivity and permit accelerated drying of the exterior insulation system, and wherein a decorative finish is applied on the surface which decorative finish is climatically determined water vapor permeable. The bonding layer and the protective layer include at least one compound selected from the group consisting of: fly ashes and pozzolanic materials consisting of metakaolin, ground brick and glass and wherein the bonding layer and the protective layer include at least one compound selected from a bio-fiber group consisting of: wood, cellulose, hemp, flax, jute or bamboo or a recycled material consisting of: expanded polystyrene and glass. The bonding layer and the protective layer of climatic stucco include at least one compound selected from a group of consisting of: bico-fibers or bio-chemical fibers or polymers (extracts from corn, guar gum and sugar cane) from and the industrial polymers and cellulose ethers in particular such as hydroxypropyl methyl cellulose. The thermo-grid is manufactured in molding process to combine polyurethane and wood and thermo-grid and is used to facilitate mounting of the second layer of thermal insulation permitting cavity drainage and accelerated drying while providing continuity of both thermal insulation layers.

The invention also further comprises a continuous, external insulation composite system comprising of a layer of permeable or semi-permeable thermal insulation arranged onto a network of thermo-grid mounted on a building wall, wherein the insulation is covered with a cladding arranged to permit accelerated drying through the exterior insulation system; and wherein the thermal insulation composite is selected from the group comprising: natural or mineral fiberboard adequately treated for fire protection, and wherein between the thermo-grid layer there is a second layer of thermal insulation selected from the group comprised of sprayed, poured or pneumatically applied thermal insulation, vacuum insulating panels or nano-gel.

1. A cladding system comprised of a method of applying a first and a second continuous insulation layer, wherein the second layer is incorporated in a fire protective, insulating composite for insulating and finishing a vertical wall structure which is impervious to water but permeable to water vapor, the method comprising the steps of:
cleaning a surface of said wall structure to be treated;
mounting a thermo-grid to the surface of the wall;
applying the primary insulation layer comprising spraying a layer of polyurethane foam between the thermo-grid,
mounting the fire protective composite to the thermo-grid; and
applying the finishing layer, comprising a climatic stucco or eco-wrap in two stages, wherein a layer of polymer modified climatic stucco and a reinforcing mesh is applied followed by an outer color and texture treatment.

2. The cladding system as recited in claim 1, wherein the primary thermal insulation is selected from the group comprising: wood, mineral fiber or insulation using a combination of fiber types (called here eco fiberboard), open or closed cell polyurethane foam, modified expanded polystyrene or vacuum insulated panels.

3. The cladding system as recited in claim 1, wherein the fire protective, insulating composite includes wood, mineral fiber or insulation using a combination of fiber types (called here eco fiberboard) and the stucco (polymer modified climatic stucco) consists of three individually applied, climate-dependent layers: (1) eco-wrap bonding layer arranged onto the layer of thermal insulation; (2) a protective stucco layer arranged with reinforcing mesh in the middle, and wherein both the bonding layer and the protective layer are comprised of capillary active or/and hygroscopic components, to achieve water resistivity and permit accelerated drying of the exterior insulation system, and wherein a decorative finish is applied on the surface which decorative finish is climatically determined water vapor permeable.

4. The cladding system as recited in claim 3, wherein the bonding layer and the protective layer include at least one compound selected from the group consisting of: fly ashes and pozzolanic materials consisting of metakaolin, ground brick and glass and wherein the bonding layer and the protective layer include at least one compound selected from a bio-fiber group consisting of: wood, cellulose, hemp, flax, jute or bamboo or a recycled material consisting of: expanded polystyrene and glass.

5. The cladding system as recited in claim 3, wherein the bonding layer and the protective layer of climatic stucco include at least one compound selected from a group of consisting of: bico-fibers or bio-chemical fibers or polymers (extracts from corn, guar gum and sugar cane) from and the industrial polymers and cellulose ethers in particular such as hydroxypropyl methyl cellulose.

6. The insulating cladding system as recited in claim 1, wherein the thermo-grid is manufactured in molding process to combine polyurethane and wood and thermo-grid and is used to facilitate mounting of the second layer of thermal insulation permitting cavity drainage and accelerated drying while providing continuity of both thermal insulation layers.

7. A continuous, external insulation composite system comprising of a layer of permeable or semi-permeable thermal insulation arranged onto a network of thermo-grid mounted on a building wall, wherein the insulation is covered with a cladding arranged to permit accelerated drying through the exterior insulation system; and wherein the thermal insulation composite is selected from the group comprising: natural or mineral fiberboard adequately treated for fire protection, and wherein between the thermo-grid layer there is a second layer of thermal insulation selected from the group comprised of sprayed, poured or pneumatically applied thermal insulation, vacuum insulating panels or nano-gel.
